(19) United States
(12) Patent Application Publication
(10) Pub. No.: US 2024/0134684 A1
(43) Pub. Date: Apr. 25, 2024

(54) CONTEXT-AWARE OPERATION ROUTING FOR DYNAMIC WORK-FLOW LAYERING

(71) Applicant: Dell Products L.P., Round Rock, TX (US)

(72) Inventors: Rishi Mukherjee, Bangalore (IN); Ravishankar Kanakapura N, Bangalore (IN); Sudhir Vittal Shetty, Cedar Park, TX (US); Stephanos S. Heracleous, Leander, TX (US)

(21) Appl. No.: 18/048,534

(22) Filed: Oct. 20, 2022

(51) Int. Cl. G06F 9/48; G06F 9/445

(52) U.S. Cl. CPC G06F 9/4881; G06F 9/44526

(57) ABSTRACT

Technology described herein relates to management of operational execution by one or more plugins, services and/or consoles of a computing system. A method can comprise registering, by a conflict resolution manager (CRM) controller of a system, a subset of control components of a set of control components of the system, wherein the registering comprises logging operation capabilities of the subset of control components, ranking, by the CRM controller, respective control components of the subset, wherein the ranking is performed based on an operation comprised by the operation capabilities, and generating, by the CRM controller, a permission for performance of the operation by a selected control component of the subset having a highest rank determined by the ranking. The control components can comprise a plugin of, or to be installed at, at least one of the system or a management console of the system, which can be a computing system.

### BACKGROUND

Operation management of a computing system comprises determining which one or more of multiple control components (e.g., services, consoles and/or plugins) are to perform an operation at the computing system. Often, two or more such control components can each be capable of, and thus attempt to, perform the operation. In one or more cases, this can cause operation failure, duplicate operations to be performed, error generation, and/or performance by a control component less capable than another control component. Due to changes in workload, control components at the computing system, and/or resources demanded by the control components to perform the operation, complexity of such operation management can be increased and/or can dynamically vary over time.

### SUMMARY

The following presents a simplified summary of the disclosed subject matter to provide a basic understanding of one or more of the various embodiments described herein. This summary is not an extensive overview of the various embodiments. It is intended neither to identify key or critical elements of the various embodiments nor to delineate the scope of the various embodiments. Its sole purpose is to present one or more concepts of the disclosure in a streamlined form as a prelude to the more detailed description that is presented later.

An example method can comprise registering, by a conflict resolution manager (CRM) controller of a system, a subset of control components of a set of control components of the system, wherein the registering comprises logging operation capabilities of the subset of control components, ranking, by the CRM controller, respective control components of the subset, wherein the ranking is performed based on an operation comprised by the operation capabilities, and generating, by the CRM controller, a permission for performance of the operation by a selected control component of the subset having a highest rank determined by the ranking.

An example system can comprise a processor, and a memory that stores executable instructions that, when executed by the processor, facilitate performance of operations. The operations can comprise assigning a priority weight to a control component of a computing system, wherein the priority weight is associated with an operation able to be performed by the control component at the computing system, identifying a request for the operation to be performed at the computing system, and instructing, based on the priority weight as compared to another priority weight associated with the operation being performed by another control component of the computing system, of the operation to be performed by the control component.

An example non-transitory computer-readable medium can comprise executable instructions that, when executed by a processor, can facilitate performance of operations. The operations can comprise evaluating current workload data representative of a current workload to be executed using an operation at a computing device and historical workload data representative of historical workload executed using the operation at a computing device, based on a request for performance of the operation, selecting a first plugin of the computing device to perform the operation, wherein the selecting is based on a result of the evaluating, and communicating with the first plugin to instruct the performance of the operation by the first plugin.

An advantage of one or more of the above-indicated method, system and/or non-transitory computer-readable medium can be dynamically adjustable operation performance by the most suitable control component (e.g., console, plugin and/or service). Accordingly, changes in workloads, workload characterization, control component availability, control component capabilities and/or resource demands can be considered and/or accounted for relative to control component workloads (e.g., which control component is granted permission to execute an operation).

Another advantage of one or more of the above-indicated method, system and/or non-transitory computer-readable medium can be setting of dynamically adjustable priority weights for various control components, which can be based on a variety of weightage factors such as, but not limited to current workloads, historical workloads, availability of resources, current configurations, an impact assessment and/or the related cluster manager.

Still another advantage of one or more of the above-indicated method, system and/or non-transitory computer-readable medium can be setting of dynamically adjustable privileges for various control components, based on the aforementioned priority weights, current capabilities and/or communications with the control components.

Yet another advantage of one or more of the above-indicated method, system and/or non-transitory computer-readable medium can be lack of reliance on human intervention for the selection of control component to satisfy a request for an operation performance, and thus prevention of human error.

### BRIEF DESCRIPTION OF THE DRAWINGS

The technology described herein is illustrated by way of example and not limited in the accompanying figures in which like reference numerals indicate similar elements.

FIG. 1 illustrates a block diagram of a computing system in combination with an operation management system, in accordance with one or more embodiments and/or implementations described herein.

FIG. 2 illustrates a block diagram of a part of the computing system of FIG. 1, in accordance with one or more embodiments and/or implementations described herein.

FIG. 3 illustrates a block diagram of an operation management system, in accordance with one or more embodiments and/or implementations described herein.

FIG. 4 illustrates a block diagram of another operation management system, in accordance with one or more embodiments and/or implementations described herein.

FIG. 5 illustrates a process flow diagram of one or more inputs and/or outputs of the operation management system of FIG. 4, in accordance with one or more embodiments and/or implementations described herein.

FIG. 6 illustrates yet another process flow diagram of one or more processes, inputs and/or outputs of the operation management system of FIG. 4, in accordance with one or more embodiments and/or implementations described herein.

FIG. 7 illustrates a process flow diagram of a method of operation management at a computing system, in accordance with one or more embodiments and/or implementations described herein.

FIG. 8 illustrates a continuation of the process flow diagram of FIG. 7 of a method of operation management at a computing system, in accordance with one or more embodiments and/or implementations described herein.

FIG. 9 illustrates a block diagram of an example operating environment into which embodiments of the subject matter described herein can be incorporated.

FIG. 10 illustrates an example schematic block diagram of a computing environment with which the subject matter described herein can interact and/or be implemented at least in part.

### DETAILED DESCRIPTION

### Overview

The technology described herein is generally directed towards determining allocation of privileges for performance of operations at a computing system, such as determining which of competing control components has permission to perform an operation at the computing system. As used herein, “control component” can refer to a service, console or plugin.

That is, complexity of system management at a computing system can increase over a period with added features or capabilities and/or due to presence of multiple consoles/plugins/services in the ecosystem. Thus, a granularity of dividing responsibilities to different functional areas e.g., configurations, compliances, change management (firmware and driver upgrades), power and thermal, serviceability, third party console extensions and/or data mining, can become more complex. This categorization of functional areas facilitates to divide the operational responsibilities between multiple consoles/plugins/services. In addition, with considerations of cluster-aware solution workflows, the complexities can further increase as many functionalities can be overlapped among the multiple consoles/plugins/services.

That is, two or more such control components can each be capable of, and thus attempt to, perform an operation. In one or more existing frameworks, this can cause operation failure, duplicate operations to be performed, error generation and/or performance by a control component less capable than another control component. This is because, as mentioned above, due to changes in workload, control components at the computing system, resources demanded by the control components to perform the operation, and/or complexity of such operation management can be increased and/or can dynamically vary over time.

For example, consider an example where an open manage enterprise (OME) has the capability of enhancing certain operations by use of certain plugins. An OME can refer to a one-to-many system management console that can facilitate cost-effective and comprehensive lifecycle management for servers at a console. Core firmware updates can be enhanced by plugins to address more sophisticated firmware update operations and/or installing firmware updates can be enhanced to provide cluster aware firmware update operations. The presence of a centralized management server plugin can allow network switches that are currently assigned to fabrics to have update orchestration and/or post install management not present with core OME. A ubiquitous multiprocessor plugin can provide for enhanced catalog creation and dup management. Typically, to accommodate these enhanced features, a user entity utilizes various different places in a console to perform these firmware update operations even though the workflow can be the same.

As another challenge, such plugins can be majoratively isolated from one another. Yet, there can be cases where the presence of one plugin can influence a feature set of another plugin in a positive way. For example, a power manager plugin can collect power related data and metrics based on its knowledge of what the OME console is able to discover and inventory the data and metrics. Presence of another plugin that introduces a new device type for discovery, inventory, and/or management operations does not necessarily trigger the power manager plugin (PMP) plugin to look at these new device types for enhanced power management operations, such as including power consumption, system anomalies and resource utilization.

That is, numerous additional issues can occur, in addition to those already mentioned above. A first issue can be that decoupling of granularities and incremental functional areas can create complexities in processing an automated or user-triggered operation as there can exist one or more overlaps in workflow processing across different functional areas (of consoles/plugins/services). Another issue can be that there can be no standard mechanism across system management consoles/plugins/services to collaborate and coordinate processing of operations to mitigate/resolve for one or more obligatory/critical operations. That is, existing frameworks do not comprise coordination between consoles and plugins/services to facilitate centralized orchestration between consoles and plugins/services, such as to determine ownership of an operation between consoles and plugins/services

Still another issue can be that non-federated functional areas deployments can limit datacenter scaling needs considered within or across geography for processing operations in collaboration. Yet another issue can be that individual consoles/plugins/services can be without notification of parallel processing from others for an automated or user-triggered operation.

As another example, a server power supply unit (PSU) failure can trigger an obligatory event that can be understood and/or addressed differently across different functional areas, which can initiate overlapping calls for actions as a result of lack of coordination. A first functional area can apply a power cap or endpoint reference to the server. A second functional area can change power supply unit configurations and limit workload. A third functional area can migrate virtual machines as suitable from the server. A fourth functional area can facilitate a firmware update of a node in a cluster of the server. That is, there can be no specific work order management for one or more operations if requested or required to be processed in synchronized fashion by multiple consoles/plugins/services.

As used herein, a functional area can comprise configuration, compliance, change management, power and thermal, serviceability, third party console extensions, data mining, etc. Solutions for these functional areas can be offered as plugins/services, such as to improve productivity, resiliency, scalability, continuous delivery/continuous integration and/or business functionality.

To account for one or more of the aforementioned deficiencies with allocating privileges for performance of operations at a computing system, one or more embodiments herein can provide a framework that can account for dynamically changing control components, configurations, capabilities, workloads and/or resource availabilities at a computing system, and based on such dynamic changes, can select a most capable, or at least a threshold capable, control component for performing an operation. This dynamically varied privilege allocation to control components can be performed on demand, at a specified frequency, in response to an operation request.

The dynamically adjustable privileges for multiple control components can be based on the aforementioned priority weights, current capabilities and/or communications with the control components. The priority weights themselves can be self-suggested by the control components, adjusted by a controller (e.g., conflict resolution manager), and/or fully determined by such conflict resolution manager (CRM) controller, such as based on a variety of weightage factors comprising, but not limited to, current workloads, historical workloads, availability of resources, current configurations, an impact assessment and/or the related cluster manager.

Any of privilege determinations, priority weight determinations and/or control component selection can be performed upon demand, in response to an operation request, and/or at any suitable repeated frequency.

Any of privilege determinations, priority weight determinations and/or control component selection can be scalable, such as one or more such processes can be performed at least partially in parallel with another process, relative to one or more operations requested, one or more control components and/or one or more control component capabilities.

Furthermore, these aforementioned processes can be automatically executed, such as by a conflict resolution manager (CRM) controller, which itself can register and log control components as they are installed and/or instantiated.

For example, as an initial brief summary of a framework described herein, such framework can employ a subscription-based methodology where each consoles/plugin that wants to handle a request will be subscribing to a “Lead Node” named as “Conflict Resolution Manager” (CRM). Responsibility of the CRM can be to proxy and intercept the incoming obligatory user or automatically triggered operational requests (on group/node). Once an operational request (on a group/node) is intercepted based on its feature published, the CRM can identify the eligible consoles/plugins and forward the operation to the right console.

Reference throughout this specification to “one embodiment,” “an embodiment,” “one implementation,” “an implementation,” etc. means that a feature, structure, or characteristic described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the features, structures, or characteristics may be combined in any suitable manner in one or more embodiments/implementations.

As used herein, with respect to any aforementioned and below mentioned uses, the term “in response to” can refer to any one or more states including, but not limited to: at the same time as, at least partially in parallel with, at least partially subsequent to and/or fully subsequent to, where suitable.

As used herein, the term “entity” can refer to a machine, device, smart device, component, hardware, software and/or human.

As used herein, the term “cost” can refer to power, money, memory and/or processing power.

As used herein, the term “power” can refer to electrical and/or other source of power available to the computing system.

As used herein, the term “resource” can refer to power, money, memory, bandwidth, processing power, hardware and/or software.

As used herein, the term “data” can comprise “metadata.”

A “managed node” can refer to IT equipment (e.g., compute, storage, networking) in a datacenter that can be on-boarded by a management console.

A “management console” can be software, such as an application, that can facilitate comprehensive lifecycle management for different types of managed nodes in a datacenter in coordination with different plugins/services.

A “plugin” can refer to a software add-on that can be installed on the management console or elsewhere, such as to enhance a capability of the management console. For example, a power manager plugin (PMP) can enable monitoring and budgeting of power based on consumption and workload needs. The PMP also can manage thermal conditions. As another example, an update manager plugin can automate the monitoring, notifications and/or downloads of system updates, such as for catalogs and repositories. A solution plugin can automate cluster aware life cycle management of the managed nodes.

The capabilities that can be enhanced can include, but are not limited to discovery inventory, health, monitoring, firmware and driver update, configuration and deployment, power management and/or thermal management.

A “group” can refer to a subset of nodes in a data center, grouped together and/or otherwise for effective and quick device management. For example, the management console or a user entity can group the nodes based on device types, functions, operating systems, user profiles and/or location.

### Example Architectures

One or more embodiments are now described with reference to the drawings, where like referenced numerals are used to refer to like elements throughout. In the following description, for purposes of explanation, numerous specific details are set forth to provide a more thorough understanding of the one or more embodiments. It is evident, however, in various cases, that the one or more embodiments can be practiced without these specific details.

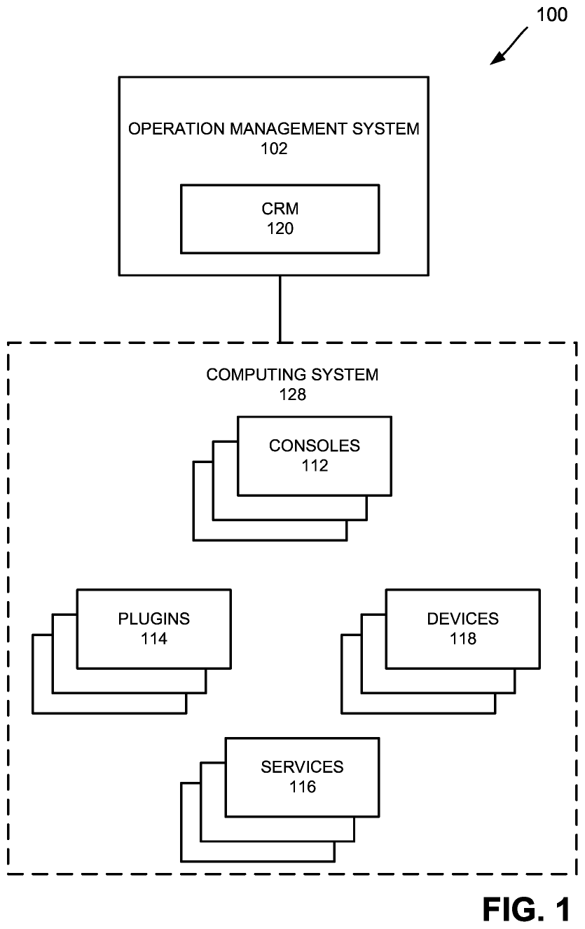

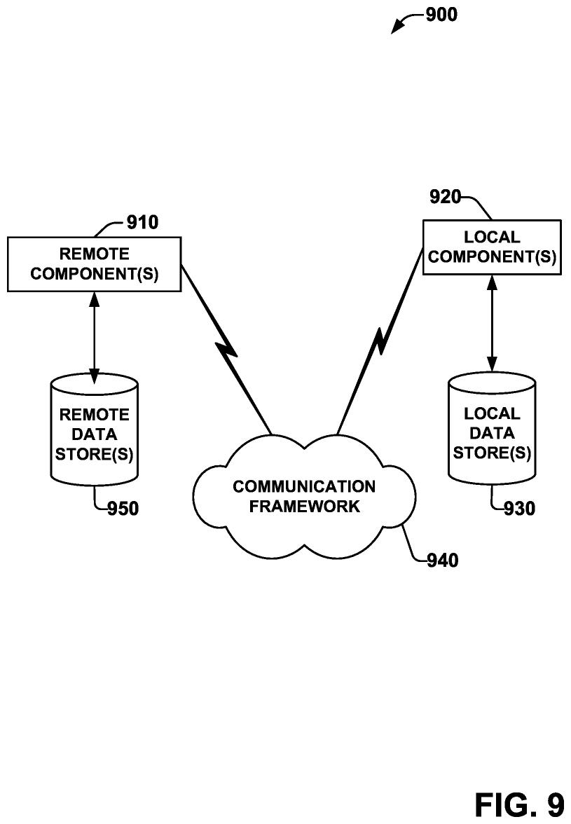

Further, the embodiments depicted in one or more figures described herein are for illustration only, and as such, the architecture of embodiments is not limited to the systems, devices and/or components depicted therein, nor to any order, connection and/or coupling of systems, devices and/or components depicted therein. For example, in one or more embodiments, the non-limiting system architectures described, and/or systems thereof, can further comprise one or more computer and/or computing-based elements described herein with reference to an operating environment, such as the operating environment 900 illustrated at FIG. 9. In one or more described embodiments, computer and/or computing-based elements can be used in connection with implementing one or more of the systems, devices, components and/or computer-implemented operations shown and/or described in connection with FIGS. 1-8 and/or with other figures described herein.

Turning first to FIG. 1, an architecture 100 is illustrated comprising a computing system 228 and an operation manage system 102 in accordance with one or more embodiments described herein.

Briefly, the operation management system (OMS) 102 can comprise at least a conflict resolution manager (CRM) controller 120, which can comprise any one or more of an application, software, hardware, processor and/or memory. The CRM controller 120 can be comprised by a processor and/or be a software-type controller.

The computing system 128 can comprise multiple consoles 112, plugins 114, services 116 and/or devices 118.

The computing system 128 and the operation management system 102 can be operably coupled by any suitable connection, network, cloud application and/or cloud service.

For example, communication can be by any suitable method. Communication can be facilitated by wired and/or wireless methods including, but not limited to, employing a cellular network, a wide area network (WAN) (e.g., the Internet), and/or a local area network (LAN). Suitable wired or wireless technologies for facilitating the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), ZIGBEE® and other 802.XX wireless technologies and/or legacy telecommunication technologies, BLUETOOTH®, Session Initiation Protocol (SIP), radio frequency for consumer electronics (RF4CE) protocol, wireless highway addressable remote transducer (WirelessHART) protocol, internet protocol version 6 (Ipv6) over Low power Wireless Area Networks (6LoWPAN), Z-Wave, an adaptive network technology (ANT) protocol, an ultra-wideband (UWB) standard/protocol and/or other proprietary and/or non-proprietary communication protocols.

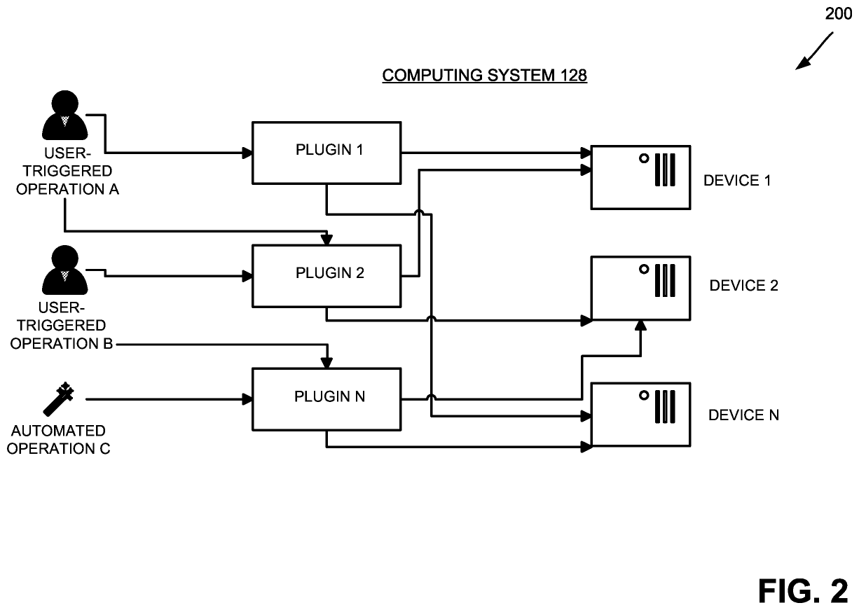

Turning next to FIG. 2, the computing system 128 is further explained based on a partial schematic 200 of the computing system 128, illustrating additional aspects/elements. While referring here to one or more processes, operations, facilitations and/or uses of the non-limiting system 200, description provided herein, above and/or below also can be relevant to one or more other non-limiting system architectures described herein (e.g., 100, 300 and/or 400). Repetitive description of like elements and/or processes employed in respective embodiments is omitted for sake of brevity.

Generally, the computing system 228 can comprise plugins 1 to N and devices 1 to N. Each plugin is not limited to operation execution relative to a single device. Rather, each plugin (or other control component) can have a capability that is relevant to any two or more devices. Also as illustrated, operation requests can be triggered by various request types, such as being user-entity triggered, administrator entity triggered, CRM-triggered, application triggered and/or otherwise automatically triggered. And further such triggering entity (e.g., device, computer, machine and/or human) can make a request directly to and/or which is relevant to two or more plugins (or other control component). Put briefly, such overlapping operations can be better controlled by an embodiment described herein.

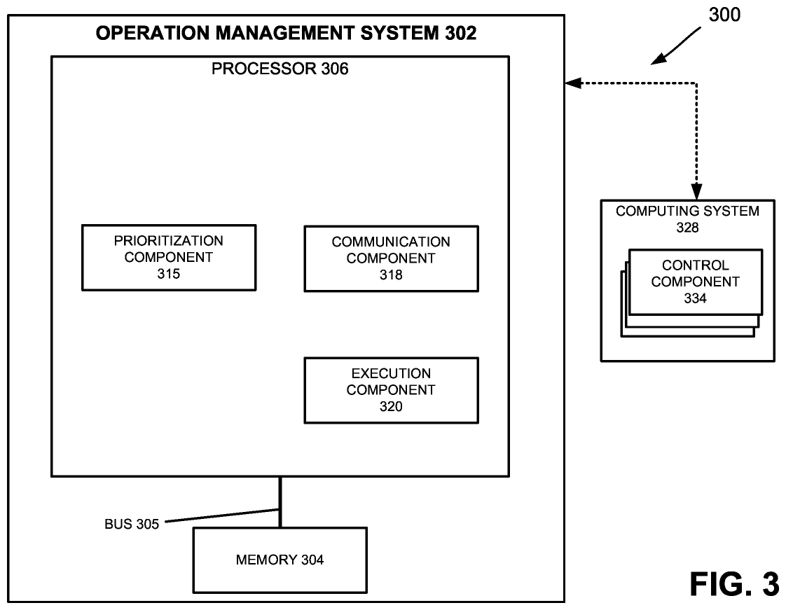

For example, turning next to FIG. 3, an architecture 300 is illustrated comprising an operation management system 302 that can function to aid a computing system, comprising multiple control components 334, by determining and applying privileges for controlling execution of operations by the control components 334. The operation management system 302 can be operably coupled to the computing system 328 by a network, cloud and/or any other suitable manner. Additional description of a computing system 328 is not again provided for sake of brevity. Description provided above relative to the computing system 128 can be applicable to the computing system 328.

Generally, the operation management system 302 can comprise any suitable computing devices, hardware, software, operating systems, drivers, network interfaces and/or so forth. As illustrated, the operation management system 302 comprises a prioritization component 315, communication component 318 and execution component 320. These components are comprised by a processor 306. Although, in one or more other embodiments, any one or more of these components can be external to the processor 306. A bus 305 operatively couples the processor 306 and a memory 304. In one or more embodiments, the processor 306 can be and/or be comprised by a controller, such as a conflict resolution management (CRM) controller, and thus the aforementioned components can be comprised by the CRM controller.

Referring briefly to the aforementioned components, the prioritization component 315 can generally assign a priority weight to a control component 334 of the computing system 328. The priority weight can be associated with an operation able to be performed by the control component 334 at the computing system 328. The communication component 318 can identify a request for the operation to be performed at the computing system 328. The execution component 320 can, based on the priority weight, such as compared to another priority weight associated with the same operation as capable of being performed by another control component 334, can instruct performance of the operation by the control component 334.

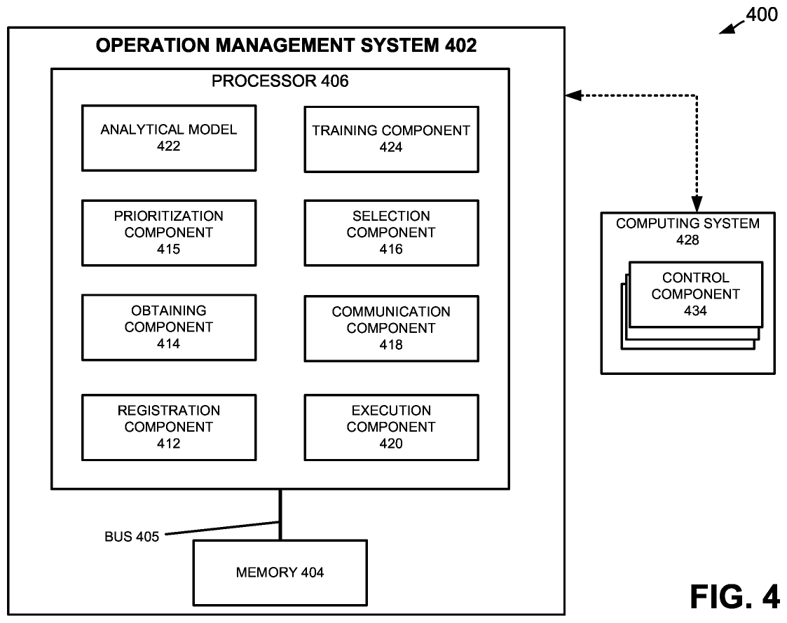

Turning next to FIG. 4, an architecture 400 is illustrated comprising an operation management system 402 that can function to aid a computing system 428 comprising multiple control components 434. The operation management system 402 can be operably coupled to the subset 430 of servers by a network, cloud and/or any other suitable manner. Additional description of the computing system 428 is not again provided for sake of brevity. Description provided above relative to the computing system 128 or 328 can be applicable to the computing system 428.

Generally, the operation management system 402 can comprise any suitable computing devices, hardware, software, operating systems, drivers, network interfaces and/or so forth. As illustrated, the operation management system 402 comprises a registration component 412, obtaining component 414, selection component 416, prioritization component 415, communication component 418, execution component 420, analytical model 422 and/or training component 424. These components can be comprised by a processor 406. A bus 405 operatively couples the processor 406 and a memory 404.

In one or more embodiments, the processor 406 can be and/or be comprised by a controller, such as a conflict resolution management (CRM) controller, and thus the aforementioned components can be comprised by the CRM controller. In one or more other embodiments, any one or more of these components can be external to the processor 406.

Communication among the components of the operation management system 402 can be by any suitable method. Communication can be facilitated by wired and/or wireless methods including, but not limited to, employing a cellular network, a WAN (e.g., the Internet), and/or a LAN. Suitable wired or wireless technologies for facilitating the communications can include, without being limited to, Wi-Fi, GSM, UMTS, WiMAX, enhanced GPRS, 3GPPLTE, 3GPP2UMB, HSPA, ZIGBEE® and other 802.XX wireless technologies and/or legacy telecommunication technologies, BLUETOOTH®, SIP, RF4CE protocol, WirelessHART protocol, 6LoWPAN, Z-Wave, an ANT protocol, a UWB standard/protocol and/or other proprietary and/or non-proprietary communication protocols.

Discussion first turns to the processor 406, memory 404 and bus 405 of the operation management system 402.

In one or more embodiments, the operation management system 402 can comprise a processor 406 (e.g., computer processing unit, microprocessor, classical processor and/or like processor). In one or more embodiments, a component associated with operation management system 402, as described herein with or without reference to the one or more figures of the one or more embodiments, can comprise one or more computer and/or machine readable, writable and/or executable components and/or instructions that can be executed by processor 406 to facilitate performance of one or more processes defined by such component and/or instruction.

In one or more embodiments, the operation management system 402 can comprise a machine-readable memory 404 that can be operably connected to the processor 406. The memory 404 can store computer-executable instructions that, upon execution by the processor 406, can cause the processor 406 and/or one or more other components of the operation management system 402 to perform one or more actions. In one or more embodiments, the memory 404 can store computer-executable components.

The operation management system 402 and/or a component thereof as described herein, can be communicatively, electrically, operatively, optically and/or otherwise coupled to one another via a bus 405 to perform functions of non-limiting system architecture 400, operation management system 402 and/or one or more components thereof and/or coupled therewith. Bus 405 can comprise one or more of a memory bus, memory controller, peripheral bus, external bus, local bus and/or another type of bus that can employ one or more bus architectures. One or more of these examples of bus 405 can be employed to implement one or more embodiments described herein.

In one or more embodiments, operation management system 402 can be coupled (e.g., communicatively, electrically, operatively, optically and/or like function) to one or more external systems (e.g., a system management application), sources and/or devices (e.g., classical communication devices and/or like devices), such as via a network. In one or more embodiments, one or more of the components of the operation management system 402 can reside in the cloud, and/or can reside locally in a local computing environment (e.g., at a specified location).

In addition to the processor 406 and/or memory 404 described above, the operation management system 402 can comprise one or more computer and/or machine readable, writable and/or executable components and/or instructions that, when executed by processor 406, can facilitate performance of one or more operations defined by such component and/or instruction.

Direction next turns first to the registration component 412, which can generally be accessed by control components 434 that are existing, newly-installed and/or newly-instantiated to the computing system 428. That is, each control component 434 can generally register with the registration component 412, which registration can comprise providing operation capabilities, description, preferences, resources employed and/or workloads employed at for each control component 434. In response, the registration component 412 can log this information at any suitable location internal or external to the operation management system 402, such as the memory 404.

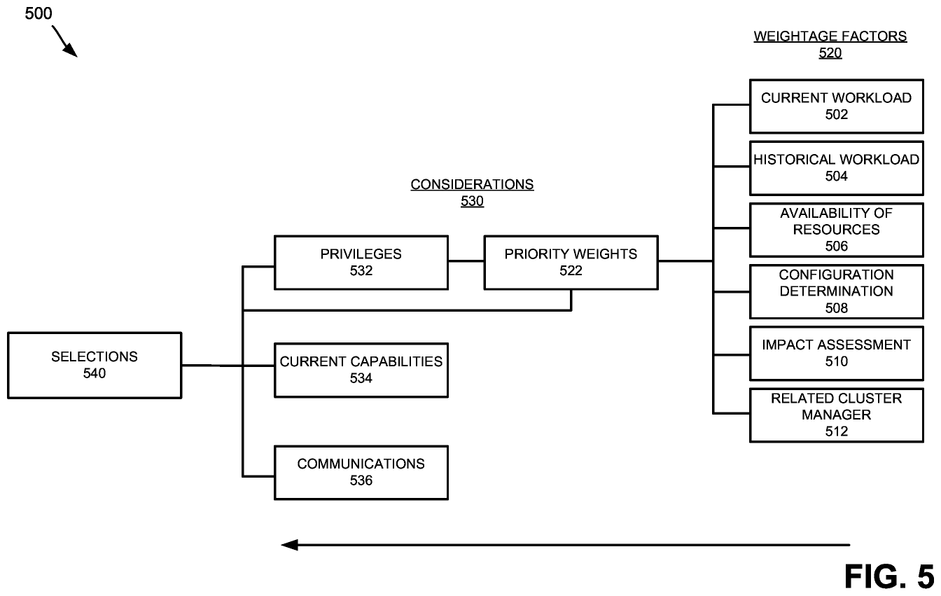

Next, turning to FIG. 5 in addition still to FIG. 4, the obtaining component 414 can receive, transmit, locate, identify and/or otherwise obtain various data (e.g., including metadata) that can be employed by the prioritization component 415 and the selection component 416 to derive one or more priority weights 522, privileges 532, and/or selections 540. As will be further described below, this data can define numerous weightage factors 520 such as, but not limited to, current workload data 502, historical workload data 504, availability of resources 506, configurations 508, impact assessments 510 and/or indications of cluster managers 512 related to an operation and/or control component 434. Further data can comprise vendor benchmark data, component classification data, telemetry data, timescale based data, power use data, performance data, key performance indicator (KPI) data and/or operation data. Any of these aspects of data can be obtained in a current (e.g., real-time) form and/or as historical (e.g., past) data. Such data can be stored at any suitable location, such as the memory 404 and/or another storage database internal to or external to the operation management system 402. The various data mentioned above is not meant to be limiting and can be in any suitable format (e.g., logs, lists, matrices and/or code).

The obtaining component 414 can obtain such data at any suitable frequency (e.g., repeated obtaining), on-demand and/or upon request. An administrator entity, user entity and/or default setting can determine the specified frequency of time.

In one or more embodiments, the obtaining component 414 can obtain a request for execution of an operation, such as from a user entity, administrator node, administrator entity, application, software and/or controller. Data representing this information can be relayed by any suitable means to the processor 406.

In one or more embodiments, the obtaining component 414 can obtain feedback for implementing an altered derivation of a priority weight 522, privilege 532, impact assessment 510 and/or selection 540. The feedback can be provided by any of a user entity, administrator node, administrator entity and/or device associated with such entities.

Turning next to the prioritization component 415, this component generally can derive a priority weight 522 for at least one control component 434. This derivation can be new and/or based on a suggested priority weight provided by a control component 434.

For example, in response to a request for an operation to be performed, the prioritization component 415, and/or the processor 406 more generally, can execute an operation to request that one or more control components 434, such as based on the aforementioned capability tables, provide respective suggested priority weights 522. For example, one or more control components 434 can be related to and/or have a capability of performing the requested operation, as indicated at one or more of the capability tables. Thus, the prioritization component 415/processor 406 can request a suggested priority weight from these one or more control components 434.

Where such suggested priority weight is provided by a control component, the prioritization component 415 can adjust the suggested priority weight, and thus output a priority weight 522. The adjustment can be based on any of the aforementioned weightage factors 520 of any one or more control components 434. For example, the prioritization component 415 can compare weightage factors 520 for two or more control components 434. In one or more embodiments, the priority weight 522 can be derived absent any comparison of weightage factors 520 for plural control components 434.

In one or more embodiments, the prioritization component 415 can consider the priority weights 522 in assigning one or more privileges 532. The privileges 532 can comprise any one or more rankings, based on any suitable ranking range, of two or more control components 434 that each can perform an operation. That is a privilege 532 can be assigned relative to an operation, category of operations and/or requested operation.

Different from the priority weights 522, a privilege 532 can take into account privileges of other control components, such as based on one or more privileges 532 of control components 434 assigned to a same group. Privileges 532 of control components 434 assigned to a same group can be the same and/or at least based upon one another. Such groupings can define plural control components 434 that are associated with a workload, operation, device, console.

In one or more embodiments, the prioritization component 415 can assign a privilege 532 and/or priority weight 522 to a control component 434. Such assignment can comprise notification to the respective control component 434 and/or to a device of the computing system 428 for which an operation is to be performed.

In one or more embodiments, these privileges 532 can be written to the respective capability tables, for later reference by one or more components 434 of the operation management system 402. This writing can be comprised by the aforementioned assignment.

It is appreciated that the one or more priority weights 522 and/or privileges 532 can be derived separate from any request for execution of an operation and/or in response to a request for a operation. In one or more embodiments, a privilege 532 can be derived proactively by the prioritization component 415 in view of a historical sequence of operations being requested in an order.

Description turns now to the communication component 418. This component can monitor communications and/or messages to identify one or more requests for an operation to be performed. In one or more embodiments, the communication component 418 can monitor for one or more aspects of data not directly requesting an operation, but having been related to such request (e.g., historically). That is, the communication component 418 can intercept the request even if the request is intended for an alternative controller and/or components.

Based on data defining the request, the selection component 416 (and/or an alternative component) can associate the request with one or more control components 434 are capable of performing the operation. This association can be based on data comprised by the capability tables and/or from the aforementioned registration.

Description turns next to the selection component 416. That is, in response to the request, the selection component 416 can perform a selection 540 of a control component 434 to be granted permission to perform the requested operation. This selection 540 can be based on various considerations 530 for one or more control components 434. That is, considerations 530 for two or more control components 434 can be compared to one another by the selection component 416.

As illustrated at FIG. 5, the considerations 530 can comprise the privileges 532, any priority weights 522, current capabilities 534 other than considered for the privilege determinations, and/or communications 536 among the processor 406 (e.g., CRM controller) and one or more control components 434.

Initially, the selection component 416 can evaluate the priority weights 522. A control component 434 having a highest priority weight 522 can be the initial candidate for the selection 540. Where two or more control components 434 have a same priority weight for a function to be performed, any one or more of the privilege 532, current capability 534 and/or communication 536 can be employed by the selection component 416. That is, a priority weight 522 (whether equal to another priority weight or not) can be overridden by any one or more of a privilege 532, current capability 534 and/or communication 536.

A privilege 532 can be newly-requested by the selection component 416, such as in response to the identification of the request by the communication component 418. Additionally, and/or alternatively, a privilege 532 can have been derived separately from any request for execution of an operation.

The current capabilities 534 can comprise data representing any one or more indications by a control component 434 that it has capability for an operation, even if not previously communicated to registration component 412, processor 406 and/or the operation management system 402 generally.

The communications 536 can comprise any data representing communications, such as negotiations, between control components 434 and/or between a control component 434 and the processor 406 (e.g., CRM controller). For example, communications 536 can involve determining whether adequate performance capability (e.g., power, bandwidth, memory) is present to allow for use of the plugin. In one example, it can be determined by the communications 536 that adequate power is not possible at a rack level to honor a higher power cap request applicable for a plugin.

Turning next to the execution component 420, this component can generally employ selection 540 determined by the selection component 416 for one or more control components 434. This employment can comprise direction to, instruction to and/or communication to the respective control component 434 of the computing system 428, and/or to a respective administrator node and/or individual node controller of the computing system 428. That is, the execution component 420 can provide permission to a control component 434, based on the considerations 530 of multiple control components that are capable of performing an operation, to perform the operation. In one or more embodiments, such execution can comprise granting permission to two or more such control components 434, such as relative to various sub-portions of an operation.

In one or more embodiments, the operation management system 402 can comprise an analytical model 422. The analytical model 422 can be, can comprise and/or can be comprised by a classical model, such as a predictive model, neural network, and/or artificial intelligence (AI) model. An artificial intelligent model and/or neural network (e.g., a convolutional network and/or deep neural network) can comprise and/or employ AI, machine learning (ML), and/or deep learning (DL), where the learning can be supervised, semi-supervised, self-supervised, semi-self-supervised and/or unsupervised. For example, the analytical model 422 can comprise an ML model.

The analytical model 422 generally can accordingly evaluate known data, such as historical data from an external source and/or newly available (e.g., real-time data) as discussed above. In one or more cases, the analytical model 422 can aid the prioritization component 415 in determining a privilege and/or the selection component 416 in selecting a control component 434.

For example, to aid the prioritization component 415, the analytical model 422 can obtain, quantify, and aggregate the various weightage factors 520 discussed above, compare the weightage factors 520 for various control components 434 to one another, and determine one more adjusted priority weights 522 and/or privileges 532. In another example, to aid the selection component 416, the analytical model 422 can obtain, quantity, and aggregate the privileges 532, additional communications 536 with the control components 434, and any changes to current capabilities 534 of the control components 434 not otherwise considered, compare these considerations 530 for various control components 434 to one another, and determine one or more selections 540 of control components 434.

Alternatively, it will be appreciated that the operation management system 402 can function absent use of the analytical model 422.

Generally, the analytical model 422 can be trained, such as by a training component 424, on a set of training data that can represent the type of data for which the system 402 will be used. That is, the analytical model 422 can be trained on historical and/or current data comprising control component parameters, capabilities, configurations and descriptions, workloads, availability of resources, configurations and/or impact assessments.

It will further be appreciated that the aforementioned processes can be repeated based on newly obtained data, such as, but not limited to, new workload characterization data, newly-available control components 434 and/or new features able to be performed by a control component 434, such as obtained by the obtaining component 414.

For example, the prioritization component 415 can, as a result, provide one or more adjusted priority weights 533. As a result thereof, the selection component 416 can determine a revised control component 434 that is given permission to perform the requested feature and/or operation.

### Example Operations

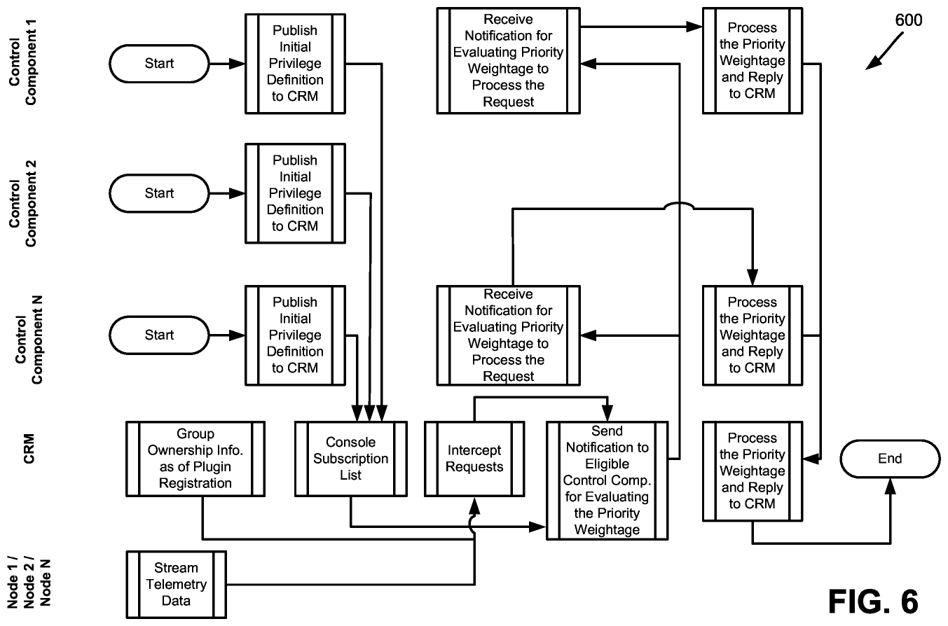

Referring now briefly to FIG. 6, an example process flow 600 is illustrated as a summary of one or more processes, inputs and/or outputs of the operation management system 402. As illustrated, a CRM controller can obtain telemetry data from one or more nodes. Initial privilege definitions can be published to a CRM controller, here defined as a service, by various consoles/plugins 1 to N. As a result, the CRM controller can generate an initial console/plugin subscription list. Based on intercepting one or more requests for an operation to be performed, the CRM controller can send notifications to eligible console/plugin's, based on the operations able to be performed by each (e.g., represented by data at the console subscription list). In response to the notification, the eligible console/plugin's (here console/plugin 1 and console/plugin N) can respond by processing a self-determined suggested priority weight and sending the same to the CRM controller for review. Based on the suggested priority weights, the CRM controller can delegate the request to a selected console/plugin. It is noted that the CRM controller can adjust the suggested priority weights into final priority weights (e.g., based on the telemetry data). It is noted that separate from a request, CRM controller can determine priority weights for one or more console/plugin's for one or more operations (e.g., based on the telemetry data). Thus, a CRM controller-determined priority weight can be employed, at least partially in parallel with a suggested priority weight from a console/plugin, to determine a selected console/plugin for a request.

### Additional Example Operations

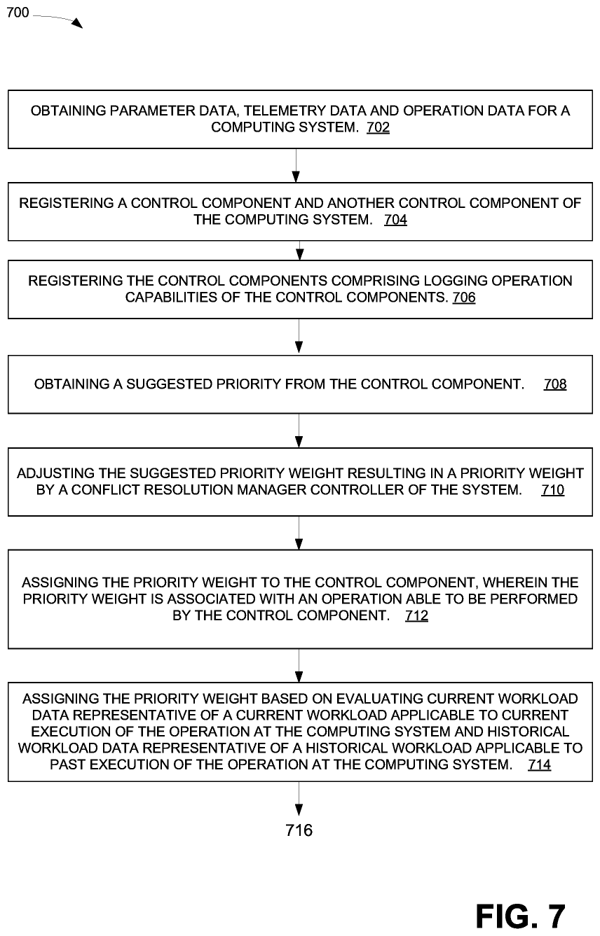

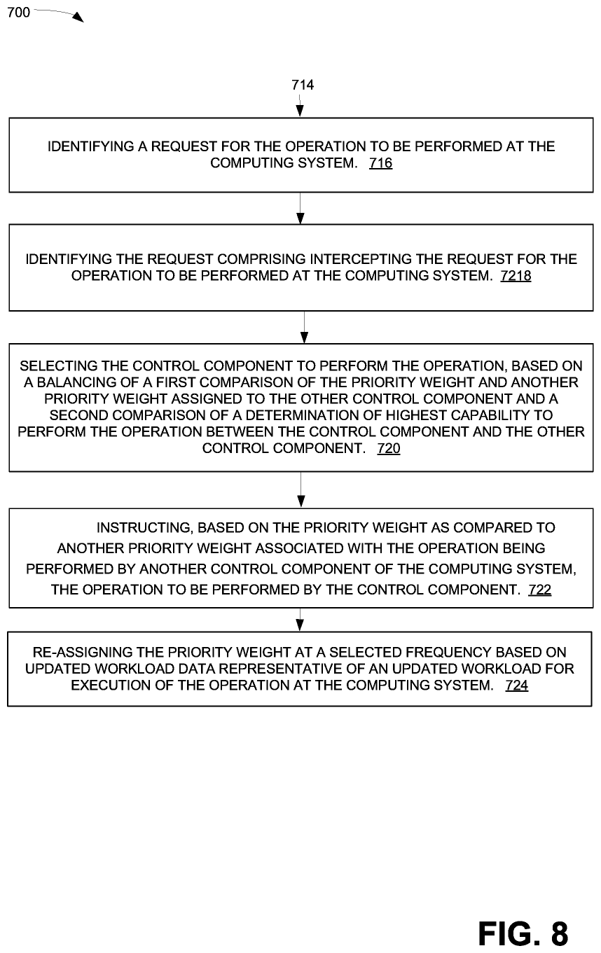

Turning now to FIGS. 7 and 8, a process flow comprising a set of operations for managing control of execution of operations at a computing system is set forth relative to FIGS. 1-6. One or more elements, objects and/or components referenced in the process flow 700 can be those of schematics 100-600. Repetitive description of like elements and/or processes employed in respective embodiments is omitted for sake of brevity.

At operation 702, the process flow 700 can comprise obtaining, by a system operably coupled to a processor (e.g., obtaining component 414), parameter data, telemetry data, and operation data for a computing system.

At operation 704, the process flow 700 can comprise registering, by the system (e.g., registration component 412), a control component and another control component of the computing system.

At operation 706, the process flow 700 can comprise registering, by the system (e.g., registration component 412) the control components comprising logging operation capabilities of the control components.

At operation 708, the process flow 700 can comprise obtaining, by the system (e.g., obtaining component 414), a suggested priority from the control component.

At operation 710, the process flow 700 can comprise adjusting, by the system (e.g., prioritization component 415), the suggested priority weight resulting in a priority weight by a conflict resolution manager controller of the system.

At operation 712, the process flow 700 can comprise assigning, by the system (e.g., prioritization component 415), the priority weight to the control component, wherein the priority weight is associated with an operation able to be performed by the control component.

At operation 714, the process flow 700 can comprise assigning the priority weight based on evaluating, by the system (e.g., prioritization component 415), current workload data representative of a current workload applicable to current execution of the operation at the computing system and historical workload data representative of a historical workload applicable to past execution of the operation at the computing system.

At operation 716, the process flow 700 can comprise identifying, by the system (e.g., communication component 418), a request for the operation to be performed at the computing system.

At operation 718, the process flow 700 can comprise identifying the request, comprising intercepting, by the system (e.g., communication component 418), the request for the operation to be performed at the computing system, and associating, by the system (e.g., selection component 416), the request with the control component based on the registering.

At operation 720, the process flow 700 can comprise selecting, by the system (e.g., selection component 416), the control component to perform the operation, based on a balancing of a first comparison of the priority weight and another priority weight assigned to the other control component and a second comparison of a determination of highest capability to perform the operation between the control component and the other control component.

At operation 722, the process flow 700 can comprise, instructing, by the system (e.g., execution component 420), based on the priority weight as compared to another priority weight associated with the operation being performed by another control component of the computing system, the operation to be performed by the control component.

At operation 724, the process flow 700 can comprise, re-assigning, by the system (e.g., prioritization component 415), the priority weight at a selected frequency based on updated workload data representative of an updated workload for execution of the operation at the computing system.

For simplicity of explanation, the computer-implemented methodologies and/or processes provided herein are depicted and/or described as a series of acts. The subject innovation is not limited by the acts illustrated and/or by the order of acts, for example acts can occur in one or more orders and/or concurrently, and with other acts not presented and described herein. The operations of process flows of the FIGS. provided herein are example operations, and there can be one or more embodiments that implement more or fewer operations than are depicted.

Furthermore, not all illustrated acts can be utilized to implement the computer-implemented methodologies in accordance with the described subject matter. In addition, the computer-implemented methodologies could alternatively be represented as a series of interrelated states via a state diagram or events. Additionally, the computer-implemented methodologies described hereinafter and throughout this specification are capable of being stored on an article of manufacture to facilitate transporting and transferring the computer-implemented methodologies to computers. The term article of manufacture, as used herein, is intended to encompass a computer program accessible from any machine-readable device or storage media.

In summary, technology described herein relates to management of operational execution by one or more plugins, services and/or consoles of a computing system. A method can comprise registering, by a conflict resolution manager (CRM) controller of a system, a subset of control components of a set of control components of the system, wherein the registering comprises logging operation capabilities of the subset of control components, ranking, by the CRM controller, respective control components of the subset, wherein the ranking is performed based on an operation comprised by the operation capabilities, and generating, by the CRM controller, a permission for performance of the operation by a selected control component of the subset having a highest rank determined by the ranking. The control components can comprise a plugin of, or to be installed at, at least one of the system or a management console of the system, which can be a computing system.

An advantage of one or more of the above-indicated method, system and/or non-transitory computer-readable medium can be dynamically adjustable operation performance by the most suitable control component (e.g., console, plugin and/or service). Accordingly, changes in workloads, workload characterization, control component availability, control component capabilities and/or resource demands can be considered and/or accounted for relative to control component workloads (e.g., which control component is granted permission to execute an operation).

Another advantage of one or more of the above-indicated method, system and/or non-transitory computer-readable medium can be setting of dynamically adjustable priority weights for multiple control components, which can be based on a variety of weightage factors such as, but not limited to current workloads, historical workloads, availability of resources, current configurations, an impact assessment and/or the related cluster manager.

Still another advantage of one or more of the above-indicated method, system and/or non-transitory computer-readable medium can be setting of dynamically adjustable privileges for multiple control components, based on the aforementioned priority weights, current capabilities and/or communications with the control components.

Yet another advantage of one or more of the above-indicated method, system and/or non-transitory computer-readable medium can be lack of reliance on human intervention for the selection of control component to satisfy a request for an operation performance, and thus prevention of human error.

One or more embodiments described herein are inherently and/or inextricably tied to computer technology and cannot be implemented outside of a computing environment. For example, one or more processes performed by one or more embodiments described herein can more efficiently, and even more feasibly, provide program and/or program instruction execution related operation routing based on dynamically changing parameters, telemetry data, workloads, etc., as compared to existing systems and/or techniques. Systems, computer-implemented methods and/or computer program products facilitating performance of these processes are of great utility in the fields of computing system management and organization and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively dynamically routing an operation or function request to a most capable and/or privileged control component as the one or more embodiments described herein can facilitate these processes. And, neither can the human mind nor a human with pen and paper automatically perform one or more of the processes as conducted by one or more embodiments described herein.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not described herein for the sake of brevity, but known by those of skill in the art.

In one or more embodiments, one or more of the processes described herein can be performed by one or more specialized computers (e.g., a specialized processing unit, a specialized classical computer, and/or another type of specialized computer) to execute defined tasks related to the one or more technologies describe above. One or more embodiments described herein and/or components thereof can be employed to solve new problems that arise through advancements in technologies mentioned above, employment of cloud computing systems, computer architecture and/or another technology.

One or more embodiments described herein can be fully operational towards performing one or more other functions (e.g., fully powered on, fully executed and/or another function) while also performing the one or more operations described herein.

### Example Operating Environment

FIG. 9 is a schematic block diagram of an operating environment 900 with which the described subject matter can interact. The operating environment 900 comprises one or more remote component(s) 910. The remote component(s) 910 can be hardware and/or software (e.g., threads, processes, computing devices). In one or more embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, radio access network devices, gateway devices, femtocell devices, servers, etc.

The operating environment 900 also comprises one or more local component(s) 920. The local component(s) 920 can be hardware and/or software (e.g., threads, processes, computing devices). In one or more embodiments, local component(s) 920 can comprise an automatic scaling component and/or programs that communicate/use the remote resources 910 and 920, etc., connected to a remotely located distributed computing system via communication framework 940.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The operating environment 900 comprises a communication framework 940 that can be employed to facilitate communications between the remote component(s) 910 and the local component(s) 920, and can comprise an air interface, e.g., interface of a UMTS network, via a LTE network, etc. Remote component(s) 910 can be operably connected to one or more remote data store(s) 950, such as a hard drive, solid state drive, subscriber identity module (SIM) card, electronic SIM (eSIM), device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

### Example Computing Environment

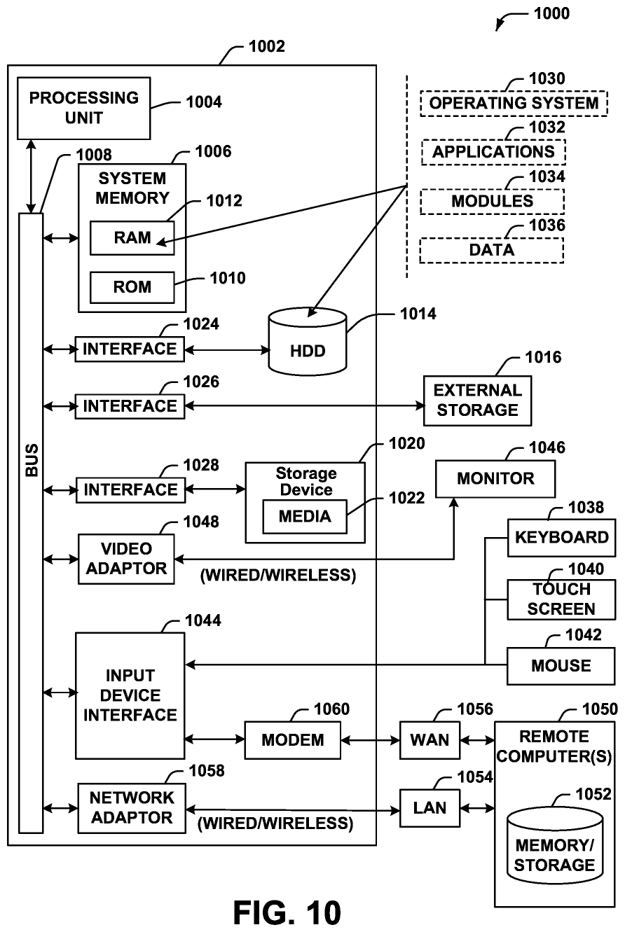

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform tasks or implement abstract data types. Moreover, the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Referring still to FIG. 10, the example computing environment 1000 which can implement one or more embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a nonvolatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), and can include one or more external storage devices 1016 (e.g., a magnetic floppy disk drive (FDD) 1016, a memory stick or flash drive reader, a memory card reader, etc.). While the internal HDD 1014 is illustrated as located within the computer 1002, the internal HDD 1014 can also be configured for external use in a suitable chassis (not shown). Additionally, while not shown in computing environment 1000, a solid-state drive (SSD) could be used in addition to, or in place of, an HDD 1014.

Other internal or external storage can include at least one other storage device 1020 with storage media 1022 (e.g., a solid-state storage device, a nonvolatile memory device, and/or an optical disk drive that can read or write from removable media such as a CD-ROM disc, a DVD, a BD, etc.). The external storage 1016 can be facilitated by a network virtual machine. The HDD 1014, external storage device 1016 and storage device (e.g., drive) 1020 can be connected to the system bus 1008 by an HDD interface 1024, an external storage interface 1026 and a drive interface 1028, respectively.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera, a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer 1050. The remote computer 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. The network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a defined structure as with a conventional network or simply an ad hoc communication between at least two devices.

### CONCLUSION

The above description of illustrated embodiments of the one or more embodiments described herein, comprising what is described in the Abstract, is not intended to be exhaustive or to limit the described embodiments to the precise forms described. While one or more specific embodiments and examples are described herein for illustrative purposes, various modifications are possible that are considered within the scope of such embodiments and examples, as those skilled in the relevant art can recognize.

In this regard, while the described subject matter has been described in connection with various embodiments and corresponding figures, where applicable, other similar embodiments can be used or modifications and additions can be made to the described embodiments for performing the same, similar, alternative, or substitute function of the described subject matter without deviating therefrom. Therefore, the described subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures to optimize space usage or enhance performance of user equipment. A processor can also be implemented as a combination of computing processing units.

As used in this application, the terms “component,” “system,” “platform,” “layer,” “selector,” “interface,” and the like are intended to refer to a computer-related entity or an entity related to an operational apparatus with one or more functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of these instances.

While the embodiments are susceptible to various modifications and alternative constructions, certain illustrated implementations thereof are shown in the drawings and have been described above in detail. However, there is no intention to limit the various embodiments to the one or more specific forms described, but on the contrary, the intention is to cover all modifications, alternative constructions, and equivalents falling within the spirit and scope.

In addition to the various implementations described herein, other similar implementations can be used, or modifications and additions can be made to the described implementation for performing the same or equivalent function of the corresponding implementation without deviating therefrom. Still further, multiple processing chips or multiple devices can share the performance of one or more functions described herein, and similarly, storage can be implemented across different devices. Accordingly, the various embodiments are not to be limited to any single implementation, but rather are to be construed in breadth, spirit, and scope in accordance with the appended claims.

What is claimed is:

1. A system, comprising:
a processor; and
a memory that stores executable instructions that, when executed by the processor, facilitate performance of operations, comprising:
assigning a priority weight to a control component of a computing system, wherein the priority weight is associated with an operation able to be performed by the control component at the computing system;
identifying a request for the operation to be performed at the computing system; and
instructing, based on the priority weight as compared to another priority weight associated with the operation being performed by another control component of the computing system, of the operation to be performed by the control component.

2. The system of claim 1, wherein the control component is a system management console, a service, or a plugin of the computing system.

3. The system of claim 1, wherein the operations executed by the processor further comprise:
selecting the control component to perform the operation, based on a balancing of a first comparison of the priority weight and the other priority weight and a second comparison of a determination of highest capability to perform the operation between the control component and the other control component.

4. The system of claim 1, wherein the assigning further comprises:
evaluating current workload data representative of a current workload applicable to current execution of the operation at the computing system and historical workload data representative of a historical workload applicable to past execution of the operation at the computing system, and
based on the evaluating, assigning the priority weight.

5. The system of claim 1, wherein the assigning further comprises:
obtaining a suggested priority weight from the control component; and
adjusting the suggested priority weight resulting in the priority weight by a conflict resolution manager controller of the system.

6. The system of claim 1, wherein the operations executed by the processor further comprise:
registering the control component and the other control component, comprising logging operation capabilities of the control component and the other control component.

7. The system of claim 6, wherein the operations executed by the processor further comprise:
intercepting the request for the operation to be performed at the computing system; and
associating the request with the control component based on the registering.

8. The system of claim 1, wherein the operations executed by the processor further comprise:
re-assigning the priority weight at a selected frequency based on updated workload data representative of an updated workload for execution of the operation at the computing system.

9. A non-transitory machine-readable medium, comprising executable instructions that, when executed by a processor facilitate performance of operations, comprising:
evaluating current workload data representative of a current workload to be executed using an operation at a computing device and historical workload data representative of historical workload executed using the operation at a computing device;
based on a request for performance of the operation, selecting a first plugin of the computing device to perform the operation, wherein the selecting is based on a result of the evaluating; and
communicating with the first plugin to instruct the performance of the operation by the first plugin.

10. The non-transitory machine-readable medium of claim 9, wherein the operations, the performance of which is facilitated by the processor, further comprise:
further basing the selecting on a comparison of operational capabilities of the first plugin and of a second plugin of the computing device.

11. The non-transitory machine-readable medium of claim 9, wherein the operations, the performance of which is facilitated by the processor, further comprise:
based on another request for the operation to be performed, re-selecting the second plugin, or a third plugin of the computing device, to perform an iteration of the operation, and
updating the priority weight at a selected frequency based on updated workload data for execution of the operation at the computing device.

12. The non-transitory machine-readable medium of claim 9, wherein the operations, the performance of which is facilitated by the processor, further comprise:
performing an impact assessment comprising a prediction of computing device performance metrics to result from the performance of the operation by the first plugin; and
further basing the selecting on result data resulting from the performing of the impact assessment.

13. The non-transitory machine-readable medium of claim 9, wherein the operations, the performance of which is facilitated by the processor, further comprise:
registering, by a conflict resolution manager controller of the system, the control component and the other control component, with the conflict resolution manager controller, comprising registering operation capabilities of the control component and the other control component.

14. The non-transitory machine-readable medium of claim 9, wherein the request is generated by at least one of the computing device or a user device associated with a user entity associated with the computing device.

15. A method, comprising:
registering, by a conflict resolution manager (CRM) controller of a system comprising a processor, a subset of control components of a set of control components of the system, wherein the registering comprises logging operation capabilities of the subset of control components;
ranking, by the CRM controller, respective control components of the subset, wherein the ranking is performed based on an operation comprised by the operation capabilities; and
generating, by the CRM controller, a permission for performance of the operation by a selected control component of the subset having a highest rank determined by the ranking.

16. The method of claim 15, wherein the control components comprise a plugin of, or to be installed at, at least one of the system or a management console of the system.

17. The method of claim 15, further comprising:
intercepting, by the CRM controller, a request for the operation to be performed at the system; and
generating, by the CRM controller, the permission in response to the request.

18. The method of claim 15, further comprising:
ranking, by the CRM controller, the control components further based on current and historical workload data for execution of the operation at the system.

19. The method of claim 15, further comprising:
sending, by the CRM controller, data defining the permission to the selected control component of the subset.

20. The method of claim 15, further comprising:
re-ranking, by the CRM controller, the control components of the subset, relative to the operation, at a selected frequency based on at least one of updated operation capabilities of the control components of the subset or current performance metrics of the system.
